(19) United States
(12) Patent Application Publication
(10) Pub. No.: US 2026/0187196 A1
(43) Pub. Date: Jul. 2, 2026

(54) TAXONOMY GUIDED RETRIEVAL AUGMENTED GENERATION IN MACHINE LEARNING MODELS

(71) Applicant: INTUIT INC., Mountain View, CA (US)

(72) Inventors: Wendi CUI, Jersey City, NJ (US); Jiaxin ZHANG, Mountain View, CA (US); Damien J. LOPEZ, Mountain View, CA (US); Colin P. RYAN, Tucson, AZ (US)

(21) Appl. No.: 19/003,036

(22) Filed: Dec. 27, 2024

(51) Int. Cl. G06F 18/241; G06F 16/334; G06F 40/166; G06F 40/205

(52) U.S. Cl. CPC G06F 18/241; G06F 16/334; G06F 40/166; G06F 40/205

(57) ABSTRACT

Aspects of the present disclosure relate to taxonomy guided retrieval augmented generation in machine learning models. Embodiments include generating a summary of each respective document in a plurality of documents and extracting attributes and relationships between the attributes from each respective summary. Embodiments include generating a hierarchy of taxonomies using a first graph and associating each document of the plurality of documents with a corresponding taxonomy of the taxonomies based on the hierarchy. Embodiments include creating an embedding associated with each document based on contents of each document and the associating and constructing a second graph containing the embedding associated with each document. Embodiments include retrieving one or more inputs to provide to a machine learning model in connection with a query based on comparing an embedding of the query to corresponding embeddings in the graph and generating a response to the query based on the one or more inputs.

### INTRODUCTION

Aspects of the present disclosure relate to techniques for taxonomy guided retrieval augmented generation in machine learning models. In particular, techniques described herein involve automatically building a taxonomy from a series of unstructured texts by extracting a summary of key entities from each document and grouping them according to their relationships, constructing a graph using embeddings generated based on the contents of the document and its taxonomy classification, and generating a response based on providing to a machine learning model one or more inputs selected by comparing an embedding of a query to corresponding embeddings in the graph.

### BACKGROUND

Every year, millions of people, businesses, and organizations around the world use software applications to assist with countless aspects of life. The use of machine learning models, including language processing machine learning models, in software applications has become widespread. Because of this, both the amount of input queries and the complexity of input queries provided to, for example, language processing machine learning models have greatly increased. Additionally, the amount of data processed by machine learning models has likewise increased. For example, when tasked with generating an output in response to one or more queries provided to that model, a machine learning model may analyze vast amounts of stored knowledge. Organizing and storing such knowledge is often associated with high computational costs. Furthermore, existing techniques often involve manual input and review for classifying information, are limited to only a single level of classification, and/or only refine an existing classification structure.

In order to generate an output in response to one or more input queries, the machine learning model may analyze such classified information. Current techniques for graph building and entity linking often result in ambiguities which may lead to inaccurate and/or inconsistent outputs generated by the machine learning model based on such linked data. Inaccurate and/or inconsistent outputs may result in providing a user with erroneous results in response to a given input, which may also require the user to run the model again to re-process the input. Such inefficiency may result in significant computational costs and energy consumption associated with machine learning models.

Thus, there is a need in the art for improved techniques for classifying and retrieving information for processing by machine learning models.

### BRIEF SUMMARY

Certain embodiments provide a method of taxonomy guided retrieval augmented generation in machine learning models. The method generally includes: generating, using a language processing machine learning model, a summary of each respective document in a plurality of documents; extracting attributes and corresponding relationships between the attributes from the summary of each respective document in the plurality of documents; generating a hierarchy of taxonomies using a first graph that is based on the attributes and the relationships; associating each document of the plurality of documents with a corresponding taxonomy of the taxonomies based on the hierarchy of the taxonomies; creating an embedding associated with each document of the plurality of documents based on contents of each document and further based on the associating; constructing a second graph containing the embedding associated with each document of the plurality of documents; retrieving one or more inputs to provide to a machine learning model in connection with a query based on comparing an embedding of the query to corresponding embeddings in the second graph; and generating a response to the query using the machine learning model based on the one or more inputs.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to taxonomy guided retrieval augmented generation in machine learning models.

FIG. 2 depicts an additional example of workflow related to taxonomy guided retrieval augmented generation in machine learning models.

FIG. 3A depicts example operations related to taxonomy guided retrieval augmented generation in machine learning models.

FIG. 3B depicts additional example operations related to taxonomy guided retrieval augmented generation in machine learning models.

FIG. 4 depicts an example of a processing system for taxonomy guided retrieval augmented generation in machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for taxonomy guided retrieval augmented generation in machine learning models.

Retrieving relevant context data to provide with a query to a machine learning model may generally be referred to as retrieval augmented generation (RAG). For example, RAG may involve optimizing the output of a machine learning model such as a language processing machine learning model by referencing an authoritative knowledge base outside of training data sources before generating a response. In order to improve RAG, techniques described herein involve automatically generating hierarchically related taxonomies based on summaries of documents, creating embedding representations of the documents based on the taxonomies and the summaries (e.g., the embeddings may thereby be representative of taxonomies as well as document contents), creating an enhanced graph representing relationships among the embeddings, and using the enhanced graph to retrieve relevant data to provide as context along with a query to a machine learning model. For example, a summary of each respective document in a plurality of documents may be generated by a machine learning model, such as a language processing machine learning model. The language processing machine learning model may, for instance, be a large language model capable of processing natural language inputs and generating natural language outputs. The summary of each respective document may be generated by parsing each respective document and extracting a subset of its content based on one or more attributes contained therein. From each summary, the language processing machine learning model may extract attributes and corresponding relationships between those attributes. Using an initial graph that is generated based on the attributes and the relationships, a hierarchy of taxonomies may be generated.

Generating the hierarchy may comprise assigning each attribute to a group and then combining related groups into one or more levels. For example, the hierarchy may be built from a first level of related groups associated with a lower measure of generality than other levels of the one or more levels to a final level of related groups associated with a higher measure of generality than the other levels of the one or more levels (i.e., creating a first, most specific level by combining the most closely related groups and incrementally combining less closely related groups until a last, most general level is created).

Next, each document may be matched with a corresponding taxonomy based on the hierarchy. Such matching may involve parsing each document and matching one or more identified attributes therein to one or more attributes contained in the one or more groups in the hierarchy. An embedding associated with each document may then be created based on contents of each document and further based on the matched taxonomy for each document (i.e., the embedding represents both the contents of the document as well as its associated taxonomy in the hierarchy of taxonomies). In some cases, an embedding model may be used to create the embeddings. After the embedding for each document is created, an enhanced graph may be constructed, such as by augmenting the initial graph based on the created document embeddings (e.g., including the embeddings in the graph, connected based on the relationships indicated in the initial graph).

The enhanced graph may be used to retrieve relevant information associated with a query (e.g., received from a user or a component of a software application) to provide along with the query as context information to a machine learning model. The relevant information may be selected and retrieved based on comparing an embedding of the query to corresponding embeddings in the enhanced graph, such as by traversing the graph based on cosine similarity or another vector similarity measure. Lastly, the machine learning model may generate a response to the query based on being provided with the relevant information retrieved using techniques described herein.

In some cases, after a response to the query is generated by the model, the response may be used to perform additional actions. For example, actions may include displaying the generated response to the query via a user interface, sending the generated response to the query to one or more elements of a software application, or a combination thereof.

Embodiments of the present disclosure provide numerous technical and practical effects and benefits. Current techniques for organizing, storing, and retrieving information to be processed by machine learning models are costly, require manual steps, are limited in their application, and often cause ambiguities which may lead to inaccurate and/or inconsistent outputs generated by the machine learning model. The result of such existing techniques is increased computational and energy costs due to implementing said techniques and potentially re-processing erroneous outputs, as well outputs of limited accuracy being generated by machine learning models (e.g., due to being provided with ambiguous, irrelevant, and/or excessive amounts of information). The present disclosure solves these technical problems. Techniques described herein ensure accurate, more relevant outputs while conserving resources. First, the present disclosure provides techniques for automatically constructing a hierarchy of taxonomies from a set of unstructured documents, by exacting key attributes from summaries of the documents and iteratively clustering them based on their relationships. This reduces time and resources needed to organize and store the vast amount of information used by machine learning models Additionally, the retrieval process is improved by creating embeddings based on both document contents and the associated taxonomy of the document, resulting in faster and more accurate results. For example, a user may submit a query asking for information related to a John Smith. If there are two John Smiths at an organization, for instance, a retrieval process using only the contents of a document or set of documents may generate incorrect and/or duplicate results (i.e., return all results for any individual named John Smith). By using embeddings created with the corresponding taxonomy information, the correct John Smith may be identified as well as the proper topic area (i.e., specific payroll information regarding John Smith). Therefore, techniques described herein may efficiently find, process, and output the correct results in response to the user's query. This results in more accurate and more pertinent results being automatically generated and provided to the user, saving time and resources both in the retrieval process (i.e., less data needs be processed) and in avoiding reproducing an alternative output or further processing and/or correcting inaccurate outputs, which would otherwise involve the use of significant computing resources.

### Example Workflows Related to Taxonomy Guided Retrieval Augmented Generation in Machine Learning Models

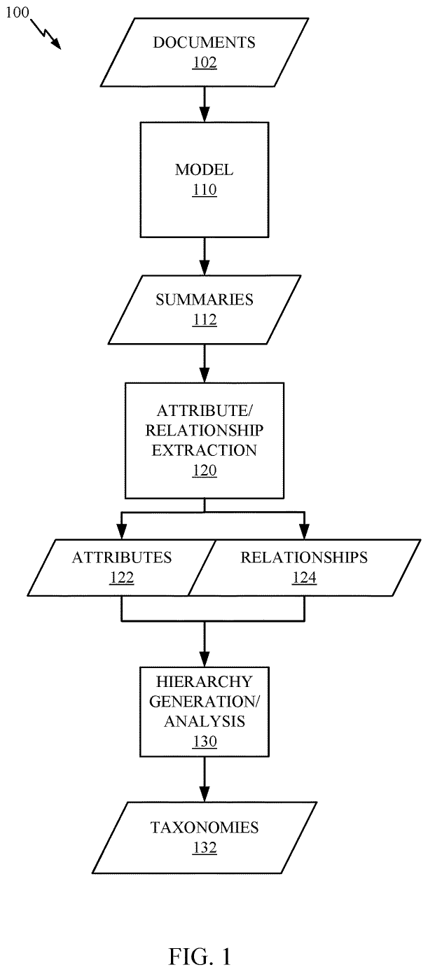

FIG. 1 depicts an example workflow 100 related to taxonomy guided retrieval augmented generation in machine learning models. For example, workflow 100 may represent a first series of steps associated with generating a taxonomy hierarchy for storing and classifying enterprise knowledge.

A model 110 may comprise a machine learning model. In a particular example, model 110 is a language processing machine learning model such as a large language model (LLM). For example, model 110 may have been trained on a large training data set in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive documents 102, which may contain a plurality of documents for processing by the model 110. The model 110 may generate a summary of each document in documents 102, collectively denoted as summaries 112. Generating the summaries 112 may comprise parsing each document of documents 102 and extracting a subset of content from a total amount of content contained in the respective document that contains one or more applicable attributes associated with the respective document. In this way, the key characteristics from each document are consolidated, resulting in a more efficient attribute extraction process. In some aspects, a prompt may be provided to model 110 along with documents 102, such as instructing model 110 to generate summaries 112. For instance, the prompt may specify that model 110 is to identify one or more attributes in a given document 102 and generate a brief summary of the contents of the given document 102 based on the identified one or more attributes, such as indicating that the summary is to be no longer than a particular length (e.g., number of characters, number of words, and/or the like) and/or indicating that the summary is to include a subset of content from a total amount of content contained in the respective document. In certain aspects, the prompt may instruct model 110 to generate a summary with automatically generated wording rather than including a subset of content from a given document 102 in the original wording of that content.

The use of model 110 to generate summaries 112 based on documents 102 may be represented by the equation Sᵢ=LLM (Dᵢ), where Sᵢ represents a summary for index i, LLM represents the use of model 110, and Dᵢ represents a document corresponding to index i, such as for a set of documents D={D₁, D₂, . . . , Dₙ} (e.g., for i=1-n).

From each summary of summaries 112, attributes 122 and relationships 124 may then be extracted, wherein the relationships 124 correspond to relationships between attributes contained in attributes 122 (e.g., a relationship may be based on the frequency with which one or more attributes occur across different summaries). Attributes 122 may represent a topic, subject, concept or any other characteristic component contained in the content of the document. In some embodiments, attributes 122 and relationships 124 are extracted from summaries 112 using model 110 or another machine learning model. For example, a prompt may be provided to model 110 or another model along with summaries 112, the prompt instructing the model to extract certain types of attributes as well as, in some aspects, relationships among those attributes, from summaries 112. Model 110 may output attributes 122 (and, in some embodiments, relationships 124) in response to the prompt (or otherwise based on its processing of summaries 112). Extracting attributes 122 (and, in some embodiments relationships 124) from summaries 112 may be represented by the following equation: Eᵢ=EntityExtraction(Sᵢ), where Eᵢ represents a set of entities (or attributes) Eᵢ={e₁, e₂, . . . , eₖ} corresponding to index i, such as for i=1-n, EntityExtraction represents an entity extraction process (e.g., involving use of model 110 or another model), and Sᵢ represents a summary 112 corresponding to index i. In some embodiments relationships 124 are directly output by model 110, while in other embodiments relationships 124 are implied by (and determined based on) the attributes 122 output by model 110. For instance, relationships 124 may be determined based on the frequency with which one or more attributes 122 occur across different summaries 112.

Attributes 122 and relationships 124 are then used to generate a hierarchy of taxonomies 132 during hierarchy generation/analysis 130. During this step, each attribute of the attributes 122 that were exacted from the documents 102 are assigned to a specified group in one or more groups. Related groups are then combined into one or more levels. The combining of related groups may comprise iteratively building the hierarchy from a first level of related groups associated with a lower measure of generality than other levels of the one or more levels to a final level of related groups associated with a higher measure of generality than the other levels of the one or more levels. In other words, the most specific (i.e., most closely related) groups are combined to form the first level and the process is repeated until a least specific (i.e., least related) grouping is created. The result is a hierarchy of taxonomies 132 with one most general level all the way down to a most specific one.

In some embodiments, the combining of related groups into the hierarchy of taxonomies may be based on a distance the calculation. The distance calculation may comprise dividing a number of the attributes containing a threshold measure of relatedness (i.e., closely related attributes) by the sum of the total number of the attributes contained in attributes 122 and a cosine similarity between one or more attributes in the one or more groups. Cosine similarity quantifies the relatedness (or similarity) of two entities (such as terms in a document) by measuring the cosine of the angle between vector representations of the entities. Alternatively, the combining of related groups into the hierarchy of taxonomies may be based on a community detection algorithm, such as a Leiden algorithm. A community detection algorithm identifies groups or communities within complex networks by partitioning a network into subgroups of nodes that are more densely connected to each other than with the rest of the network (i.e., nodes within the same community have stronger connections to each other compared to nodes in different communities).

In certain embodiments, hierarchy generation 130 (and/or, otherwise, generation of relationships 124 and/or taxonomies 132) may be represented by the following logic. First, the weight of a relationship 124 between two nodes (corresponding to two entities or attributes) eᵢ and eⱼ may be determined by counting how many documents contain both entities. If Aᵢⱼ represents the weight between nodes eᵢ and eⱼ, then Aᵢⱼ may be determined by the following formula: Aᵢⱼ=({Dₖ|eᵢ, eⱼ∈Dₖ}| where Dₖ represents a document corresponding to index k and ∈ means “are included in”. This weight represents the strength of the relationship between the two entities across the document corpus. Next, a Leiden technique may be applied to detect communities within the graph formed by the entities (or attributes) and their relationships (or weights Aᵢⱼ). The goal is to maximize the modularity of the graph, creating well-connected clusters of entities. For example, community detection, or the determination of a partition quality Q representing how well a set of communities partition a graph, may be represented by the following formula:

$$Q = \frac{1}{2 m} {\sum }_{i , j} ( {A}_{i j} - \frac{{k}_{i} {k}_{j}}{2 m} ) δ ( {C}_{i} , {C}_{j} ) ,$$

where Aᵢⱼ is edge weight between nodes i and j (or the adjacency matrix), kᵢ and kⱼ are the degrees of nodes i and j (e.g., the sum of the weights of the edges attached to nodes i and j, respectively), m is the sum of all of the edge weights in the graph, and δ(Cᵢ,Cⱼ) is 1 if nodes i and j belong to the same community and 0 otherwise.

For each community detected, model 110 or another machine learning model (e.g., another LLM) may be used to generate a label representing a lowest level of the taxonomy. The importance of each entity eᵢ in the community may be determined by the sum of its edges Σ Aᵢⱼ, and this importance may be considered when generating the label: importance (eᵢ)=Σⱼ Aᵢⱼ. The model may take this importance into account when proposing a taxonomy label for the community.

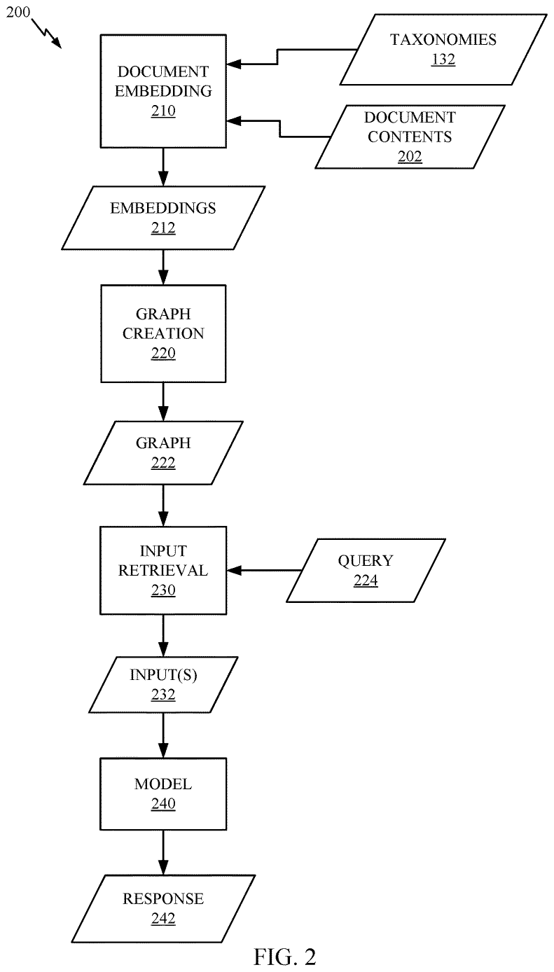

Next, agglomerative clustering may be used to iteratively merge the closest communities to form a higher-level taxonomy. The distance between two communities Cᵢ and Cⱼ may be calculated as

$$d ( {C}_{i} , {C}_{j} ) = \frac{\vert {E}_{i j} \vert}{\vert {C}_{i} \vert + \vert {C}_{j} \vert} + cosine\_similarity ( {v}_{i} , {v}_{j} ) ,$$

where |Eᵢⱼ| is the number of nodes directly linked between the communities, and cosine_similarity(vᵢ, vⱼ) is the cosine similarity between the most connected nodes in each community. Such an agglomerative clustering process may be repeated until all communities are merged into a single taxonomy structure. The final taxonomy (e.g., taxonomies 132) is hierarchical, with broader categories at the top and more specific ones at the bottom. The generated taxonomy may serve as the base structure for a new graph, as describes in more detail below with respect to FIG. 2.

FIG. 2 depicts an additional example workflow 200 related to taxonomy guided retrieval augmented generation in machine learning models. In particular, FIG. 2 depicts a second series of steps to be performed using model 110 subsequent to those depicted in FIG. 1, such as performing graph-based retrieval augmented generation using the taxonomy hierarchy.

During document embedding 210, taxonomies 132 and document contents 202 may be used to generate embeddings 212. For example, document embedding 210 may comprise associating each document of the plurality of documents with a corresponding taxonomy of the taxonomies, by parsing each document of the plurality of documents (e.g., using a machine learning model such as model 110 or another language processing machine learning model, such as during creation of the hierarchy or otherwise) and matching one or more identified attributes (e.g., one or more of attributes 122 of FIG. 1 and/or one or more other attributes output by a model or otherwise identified) therein to one or more attributes contained in the one or more groups in the hierarchy, and then providing, to an embedding model, each document of the plurality of documents and the corresponding taxonomy for each document. An embedding generally refers to a vector representation of an entity (e.g., a document) that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, an embedding model used to generate embeddings comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

The embeddings 212 generated from document embedding 210 may contain an embedding associated with each document in the plurality of documents 102. Each embedding in embeddings 212 will be based on information related to both the content of the document and but also its associated taxonomy from the hierarchy of taxonomies. For instance, a financial transaction document regarding customer payments may be classified under Finance→Payment, while a Human Resources payroll document regarding employee salary payments may be classified under Human Resources→Payment. This results in a more accurate embedding that more fully encapsulates all available information about the document and allows for an improved retrieval process as described below. The embeddings 212 are then used during graph creation 220 to construct graph 222 which contains each embedding in embeddings 212.

Generally, constructing graph 222 may be part of a solution for graph-based retrieval augmented generation to answer queries based on a set of documents D={D₁, D₂, . . . , Dₙ} where each document Dᵢ contains textual information. A query q is a member of Q, where Q represents the set of potential user queries, and constructing graph 222 may be referred to as constructing a dynamically generated graph G=(V,E), where V represents the nodes (entities or concepts extracted from the documents), and E represents the weighted edges (relationships between these entities based on their co-occurrence in the documents). The goal may be to retrieve relevant information from the documents in D to answer the query q, leveraging both the content of the documents and the structure of the graph G. The primary objective may be to maximize the relevance of the information retrieved in response to the query q. Formally, the aim may be to maximize the relevance score R(q,A), where A is the set of answers retrieved from the graph-based retrieval system, based on the query q: maximize R(q,A) where R(q,A) is the relevance score, which is computed as a combination of: content similarity between the query q and the documents in D, and structural similarity between the nodes in the graph G and the query.

For example, the taxonomy nodes T={T₁, T₂, . . . , Tₘ} generated as described above with respect to FIG. 1 may act as base nodes in the graph with a specific node type. When creating nodes from documents, each document Dᵢ is classified under a specific taxonomy category Tⱼ, ensuring that all nodes are linked to a taxonomy chain: Link(Dᵢ,Tⱼ) ∀eₖ∈Eᵢ. This linkage solves the ambiguity that can arise during graph construction by ensuring each node is anchored to a specific taxonomy chain. Each node vᵢ in the graph G (e.g., graph 222) is embedded with both its individual information and the taxonomy chain information. The final embedding

$${v}_{i}^{final}$$

is composed or the node s individual content embedding vᵢ and its taxonomy embedding tᵢ:

$${v}_{i}^{final} = {v}_{i} + λ {t}_{i} ,$$

where λ controls the weighting of the taxonomy information in the final embedding.

In response to a query 224, one or more input(s) 232 may be retrieved based on comparing an embedding of the query 224 to corresponding embeddings in the graph 222. Comparing the embeddings may comprise, for example, traversing the graph 222 based on cosine similarity. For example, when a query q arrives, its embedding q^{final} may be generated by combining its content embedding q^{content} with the embedding of the taxonomy chain to which the query maps: q^{final}=q^{content}+λt_{q}. For example, generating an embedding of the query may comprise associating the query with a corresponding taxonomy of the taxonomies, by parsing the query (e.g., using a machine learning model such as model 110 or another language processing machine learning model) and matching one or more identified attributes (e.g., output by a model or otherwise identified) and matching one or more identified attributes therein to one or more attributes contained in the one or more groups in the hierarchy, and then providing, to an embedding model, the query and the corresponding taxonomy for the query. This technique ensures that the query is processed in the context of the taxonomy, allowing for accurate entity linking and retrieval. For instance, q^{final} may be compared to

$${v}_{i}^{final}$$

for one or more nodes vᵢ in the graph to determine which nodes are within a threshold amount of similarity with respect to the query. For example, given the query embedding q^{final}, the system retrieves a set of relevant nodes V_{q}∈V from the graph G, where the relevance score between the query q and each node vᵢ∈V_{q} is computed based on both content and structural similarity. Such similar node(s) may be retrieved as input(s) 232. The final set of answers A is derived from these relevant nodes. The task may be to maximize the relevance of the selected answers: A*=argmax R(q,A), where A* is the optimal set of answers that maximizes the relevance score with respect to the query q.

For instance, the input(s) 232 may be provided to a model 240, such as a machine learning model, such as along with query 224. For example, model 240 may be the same as model 110 of FIG. 1 or may be a different model. Generally, model 240 may be a generative machine learning model capable of generating a response to query 224 based on input(s) 232. For example, model 240 may be an LLM, a generative adversarial network (GAN), an autoencoder model, an autoregressive model, a diffusion model, a Bayesian network, a hidden Markov model, and/or the like. The model 240 may generate a response 242 based on the input(s) 232. An action may be performed based on the response 242 to the query 224, such as displaying the response 242 via a user interface, sending the response 242 to one or more components of a software application, or both.

In one example, a query 224 may be received that states “Show me payment details.” In response, an embedding of the query may be generated (e.g., by using the embedding model) based on both the content of that query as well as a corresponding mapping in the taxonomy hierarchy. For instance, that taxonomy may be related to Finance or Human Resources. The query embedding may then be compared to the embeddings in the graph 222 using, for example, cosine similarity. If the query pertains to an employee salary, then it may be linked to Human Resources→Payment, while the query may be linked to Finance→Payment if it pertains to customer payments. Once the relevant taxonomy link is selected, the corresponding information may be provided to the model 240 as input(s) 232. The model 240 may process the input(s) 232 and generate a response 242 (e.g., output a summary of customer payment details from the finance department). This process ensures that the most relevant and accurate information is selected and provided to the user by combining content information and taxonomy information in the embeddings. This eliminates confusion associated with a query, such as the example query provided above, that could relate to more than one department, committee, topic, subject area, etc.

Experimental results suggest that techniques described herein provide significant performance improvements compared to other techniques (e.g., retrieval augmented generation processes that do not involve taxonomy-based techniques described herein), such as improved semantic consistency, factual consistency, and summarization consistency between a reference (e.g., a query) and identified candidates (e.g., entities that are retrieved to be provided as inputs along with the query to a machine learning model). Overall rates of consistency improvement in experiments ranged from 86.7% to 97.67%.

The graph G (e.g., graph 222) may be dynamically updated as new documents are added to the corpus D, such as using techniques described above. The retrieval process described herein may be able to efficiently handle large-scale document sets D and graph structures G while maintaining high relevance and accuracy. Thus, techniques described herein involve dynamically organizing entities into a hierarchical taxonomy, allowing for efficient and accurate query answering based on both content and structural relationships.

### Example Operations Related to Taxonomy Guided Retrieval Augmented Generation in Machine Learning Models

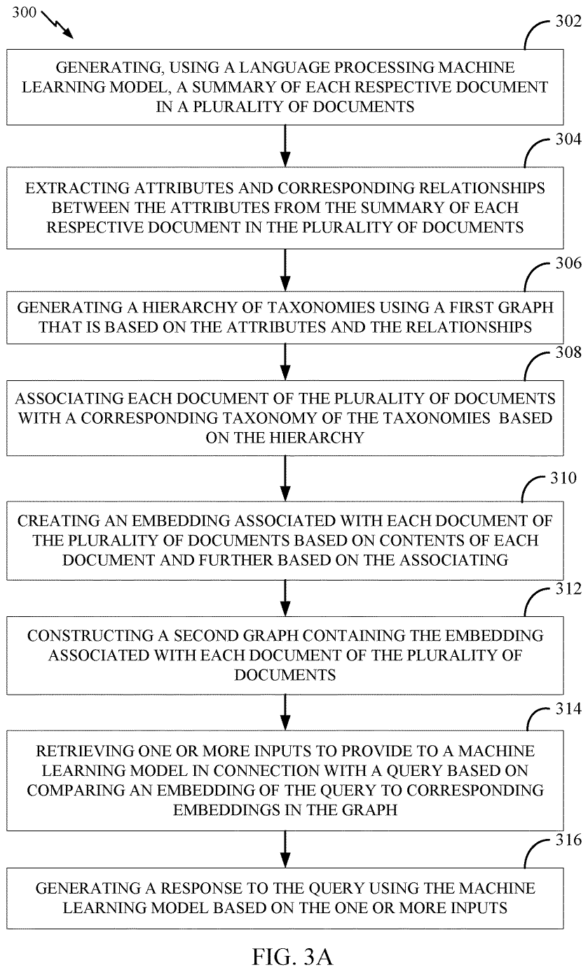

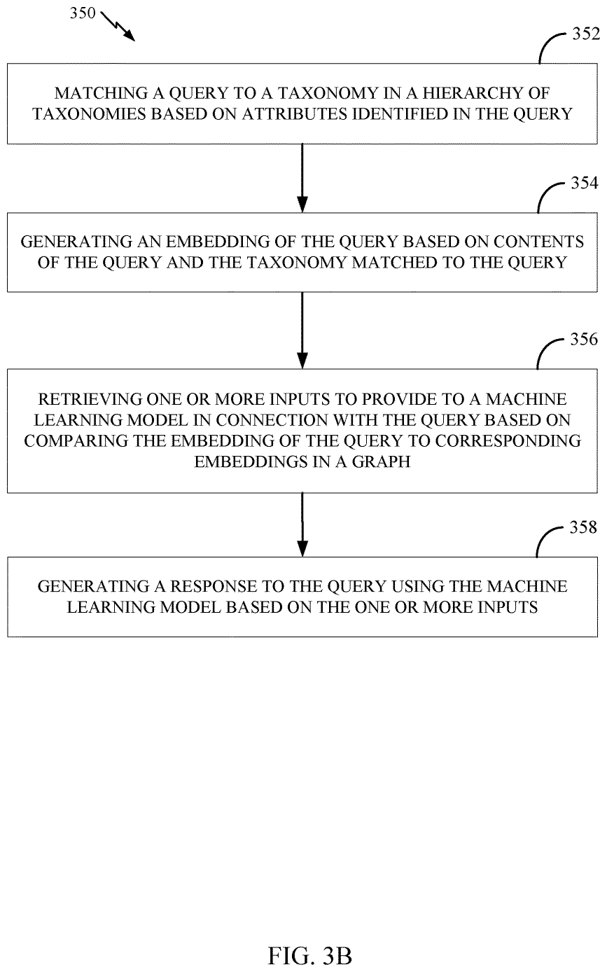

FIG. 3A depicts example operations 300 related to taxonomy guided retrieval augmented generation in machine learning models. For example, operations 300 may be performed by one or more of the components described with respect to FIG. 1 and/or FIG. 2.

Operations 300 begin at step 302 with generating, using a language processing machine learning model, a summary of each respective document in a plurality of documents. In certain embodiments, the generating of the summary of each respective document in the plurality of documents comprises parsing the respective document and extracting a subset of content from a total amount of content contained in the respective document that contains one or more applicable attributes associated with the respective document for providing to the language processing machine learning model.

Operations 300 continue at step 304 with extracting attributes and corresponding relationships between the attributes from the summary of each respective document in the plurality of documents.

Operations 300 continue at step 306 with generating a hierarchy of taxonomies using a first graph that is based on the attributes and the relationships. According to some embodiments, the generating of the hierarchy of the taxonomies using the first graph that is based on the attributes and the relationships comprises assigning each attribute of the attributes to a specified group in one or more groups and combining related groups into one or more levels based on one or more of: a distance calculation; or a community detection algorithm, wherein the community detection algorithm comprises a Leiden algorithm. Certain embodiments provide that the distance calculation comprises dividing a number of the attributes containing a threshold measure of relatedness by a sum of a total number of the attributes and a cosine similarity between one or more attributes in the one or more groups. In other embodiments, the combining of the related groups into the one or more levels further comprises iteratively building the hierarchy of the taxonomies from a first level of related groups associated with a lower measure of generality than other levels of the one or more levels to a final level of related groups associated with a higher measure of generality than the other levels of the one or more levels.

Operations 300 continue at step 308 with associating each document of the plurality of documents with a corresponding taxonomy of the taxonomies based on the hierarchy of the taxonomies. In some embodiments, the associating of each document of the plurality of documents with the corresponding taxonomy of the taxonomies based on the hierarchy of the taxonomies comprises parsing each document of the plurality of documents and matching one or more identified attributes therein to one or more attributes contained in the one or more groups in the hierarchy of the taxonomies.

Operations 300 continue at step 310 with creating an embedding associated with each document of the plurality of documents based on contents of each document and further based on the associating. According to certain embodiments, the creating of the embedding of each document of the plurality of documents based on the contents of each document and further based on the associating comprises providing, to an embedding model, each document of the plurality of documents and the corresponding taxonomy for each document of the plurality of documents.

Operations 300 continue at step 312 with constructing a second graph containing the embedding associated with each document of the plurality of documents.

Operations 300 continue at step 314 with retrieving one or more inputs to provide to a machine learning model in connection with a query based on comparing an embedding of the query to corresponding embeddings in the second graph. Some embodiments provide that the comparing of the embedding of the query to the corresponding embeddings in the second graph comprises traversing the second graph based on cosine similarity.

Operations 300 continue at step 316 with generating a response to the query using the machine learning model based on the one or more inputs.

In certain embodiments, the method further comprises performing an action based on the generated response to the query, wherein the performing of the action comprises one or more of: displaying the generated response to the query via a user interface; or sending the generated response to the query to one or more components of a software application.

FIG. 3B depicts additional example operations 350 related to taxonomy guided retrieval augmented generation in machine learning models. For example, operations 350 may be performed by one or more of the components described with respect to FIG. 1 and/or FIG. 2.

Operations 350 begin at step 352 with matching a query to a taxonomy in a hierarchy of taxonomies based on attributes identified in the query.

Operations 350 continue at step 354 with generating an embedding of the query based on contents of the query and the taxonomy matched to the query.

Operations 350 continue at step 356 with retrieving one or more inputs to provide to a machine learning model in connection with the query based on comparing the embedding of the query to corresponding embeddings in a graph.

Operations 350 continue at step 358 with generating a response to the query using the machine learning model based on the one or more inputs.

In some embodiments, the hierarchy of taxonomies is based on relationships between attributes of a plurality of documents. According to certain embodiments, the graph is based on the hierarchy of taxonomies and the graph comprises embeddings of the plurality of documents that are based on contents of the documents and taxonomies from the hierarchy of taxonomies that are matched to the documents.

### Example of a Processing System for Taxonomy Guided Retrieval Augmented Generation in Machine Learning Models

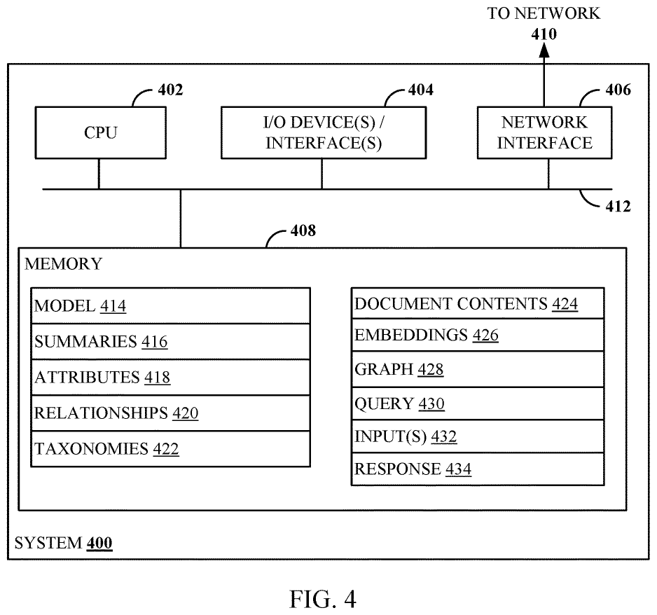

FIG. 4 illustrates an example system 400 with which embodiments of the present disclosure may be implemented. For example, system 400 may be configured to perform operations 300 of FIG. 3A or operations 350 FIG. 3B and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes model 414, summaries 416, attributes 418, relationships 420, and taxonomies 422. Model 414 may be representative of model 110 of FIG. 1 and model 240 of FIG. 2. Summaries 416 may be representative of summaries 112 of FIG. 1. Attributes 418 may be representative of attributes 122 of FIG. 1. Relationships 420 may be representative of relationships 124 of FIG. 1. Taxonomies 422 may be representative of taxonomies 132 of FIG. 1 and FIG. 2.

Memory 408 further comprises document contents 424 which may correspond to document contents 202 of FIG. 2. Memory 408 further comprises embeddings 426, which may correspond to embeddings 212 of FIG. 2. Memory 408 further comprises graph 428, which may correspond to graph 222 of FIG. 2. Memory 408 further comprises query 430, which may correspond to query 224 of FIG. 2. Memory 408 further comprises input(s) 432, which may correspond to input(s) 232 of FIG. 2. Memory 408 further comprises response 434, which may correspond to response 242 of FIG. 2. It is noted that in some embodiments, system 400 may interact with one or more external components, such as via network 410, in order to retrieve data and/or perform operations. Furthermore, techniques described herein may be implemented via more or fewer components than those shown and described with respect to FIG. 4, such as on one or more computing systems.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for taxonomy guided retrieval augmented generation in machine learning models, comprising:
generating, using a language processing machine learning model, a summary of each respective document in a plurality of documents;
extracting attributes and corresponding relationships between the attributes from the summary of each respective document in the plurality of documents;
generating a hierarchy of taxonomies using a first graph that is based on the attributes and the relationships;
associating each document of the plurality of documents with a corresponding taxonomy of the taxonomies based on the hierarchy of the taxonomies;
creating an embedding associated with each document of the plurality of documents based on contents of each document and further based on the associating;
constructing a second graph containing the embedding associated with each document of the plurality of documents;
retrieving one or more inputs to provide to a machine learning model in connection with a query based on comparing an embedding of the query to corresponding embeddings in the second graph; and
generating a response to the query using the machine learning model based on the one or more inputs.

2. The method of claim 1, wherein the generating of the summary of each respective document in the plurality of documents comprises parsing the respective document and extracting a subset of content from a total amount of content contained in the respective document that contains one or more applicable attributes associated with the respective document for providing to the language processing machine learning model.

3. The method of claim 1, wherein the generating of the hierarchy of the taxonomies based on the attributes and the relationships comprises assigning each attribute of the attributes to a specified group in one or more groups and combining related groups into one or more levels based on one or more of:
a distance calculation; or
a community detection algorithm, wherein the community detection algorithm comprises a Leiden algorithm.

4. The method of claim 3, wherein the distance calculation comprises dividing a number of the attributes containing a threshold measure of relatedness by a sum of a total number of the attributes and a cosine similarity between one or more attributes in the one or more groups.

5. The method of claim 3, wherein the combining of the related groups into the one or more levels based on the distance calculation further comprises iteratively building the hierarchy of the taxonomies from a first level of related groups associated with a lower measure of generality than other levels of the one or more levels to a final level of related groups associated with a higher measure of generality than the other levels of the one or more levels.

6. The method of claim 3, wherein the associating of each document of the plurality of documents with the corresponding taxonomy based on the hierarchy of the taxonomies comprises parsing each document of the plurality of documents and matching one or more identified attributes therein to one or more attributes contained in the one or more groups in the hierarchy of the taxonomies.

7. The method of claim 1, wherein the creating of the embedding of each document of the plurality of documents based on the associating comprises providing, to an embedding model, each document of the plurality of documents and the corresponding taxonomy for each document of the plurality of documents.

8. The method of claim 1, wherein the comparing of the embedding of the query to the corresponding embeddings in the second graph comprises traversing the second graph based on cosine similarity.

9. The method of claim 1, further comprising:
performing an action based on the generated response to the query, wherein the performing of the action comprises one or more of:
displaying the generated response to the query via a user interface; or
sending the generated response to the query to one or more components of a software application.

10. A system for taxonomy guided retrieval augmented generation in machine learning models, comprising:
one or more processors; and
a memory comprising instructions that, when executed by the one or more processors, cause the system to:
generate, using a language processing machine learning model, a summary of each respective document in a plurality of documents;
extract attributes and corresponding relationships between the attributes from the summary of each respective document in the plurality of documents;
generate a hierarchy of taxonomies using a first graph that is based on the attributes and the relationships;
associate each document of the plurality of documents with a corresponding taxonomy of the taxonomies based on the hierarchy of the taxonomies;
create an embedding associated with each document of the plurality of documents based on contents of each document and further based on the associating;
construct a second graph containing the embedding associated with each document of the plurality of documents;
retrieve one or more inputs to provide to a machine learning model in connection with a query based on comparing an embedding of the query to corresponding embeddings in the second graph; and
generate a response to the query using the machine learning model based on the one or more inputs.

11. The system of claim 10, wherein the generating of the summary of each respective document in the plurality of documents comprises parsing the respective document and extracting a subset of content from a total amount of content contained in the respective document that contains one or more applicable attributes associated with the respective document for providing to the language processing machine learning model.

12. The system of claim 10, wherein the generating of the hierarchy of the taxonomies based on the attributes and the relationships comprises assigning each attribute of the attributes to a specified group in one or more groups and combining related groups into one or more levels based on one or more of:
a distance calculation; or
a community detection algorithm, wherein the community detection algorithm comprises a Leiden algorithm.

13. The system of claim 12, wherein the distance calculation comprises dividing a number of the attributes containing a threshold measure of relatedness by a sum of a total number of the attributes and a cosine similarity between one or more attributes in the one or more groups.

14. The system of claim 12, wherein the combining of the related groups into the one or more levels based on the distance calculation further comprises iteratively building the hierarchy of the taxonomies from a first level of related groups associated with a lower measure of generality than other levels of the one or more levels to a final level of related groups associated with a higher measure of generality than the other levels of the one or more levels.

15. The system of claim 12, wherein the associating of each document of the plurality of documents with the corresponding taxonomy based on the hierarchy of the taxonomies comprises parsing each document of the plurality of documents and matching one or more identified attributes therein to one or more attributes contained in the one or more groups in the hierarchy of the taxonomies.

16. The system of claim 10, wherein the creating of the embedding of each document of the plurality of documents based on the associating comprises providing, to an embedding model, each document of the plurality of documents and the corresponding taxonomy for each document of the plurality of documents.

17. The system of claim 10, wherein the comparing of the embedding of the query to the corresponding embeddings in the second graph comprises traversing the second graph based on cosine similarity.

18. The system of claim 10, wherein the instructions, when executed by the one or more processors, further cause the system to:
perform an action based on the generated response to the query, wherein the performing of the action comprises one or more of:
displaying the generated response to the query via a user interface; or
sending the generated response to the query to one or more components of a software application.

19. A method for taxonomy guided retrieval augmented generation in machine learning models, comprising:
matching a query to a taxonomy in a hierarchy of taxonomies based on attributes identified in the query;
generating an embedding of the query based on contents of the query and the taxonomy matched to the query;
retrieving one or more inputs to provide to a machine learning model in connection with the query based on comparing the embedding of the query to corresponding embeddings in a graph; and
generating a response to the query using the machine learning model based on the one or more inputs.

20. The method of claim 19, wherein the hierarchy of taxonomies is based on relationships between attributes of a plurality of documents, wherein the graph is based on the hierarchy of taxonomies, and wherein the graph comprises embeddings of the plurality of documents that are based on contents of the documents and taxonomies from the hierarchy of taxonomies that are matched to the documents.
